(19) United States
(12) Patent Application Publication
(10) Pub. No.: US 2016/0060032 A1
(43) Pub. Date: Mar. 3, 2016

(54) WAREHOUSE REORGANIZATION METHOD AND THE COMPUTER PROGRAM THEREOF

(71) Applicant: SAMSUNG SDS CO., LTD., Seoul (KR)

(72) Inventors: Su Dong KIM, Seoul (KR); Dae Beom CHO, Seoul (KR)

(73) Assignee: SAMSUNG SDS CO., LTD., Seoul (KR)

(21) Appl. No.: 14/843,153

(22) Filed: Sep. 2, 2015

(30) Foreign Application Priority Data
Sep. 2, 2014 (KR) 10-2014-0116449

(51) Int. Cl. B65G 1/04; G05B 15/02

(52) U.S. Cl. CPC B65G 1/04; G05B 15/02

(57) ABSTRACT

A method for warehouse reorganization includes determining, by a warehouse management device, an item to be relocated; retrieving, by the warehouse management device, a plurality of load cells on which the determined item is loaded and to which a merge task has not been applied; and generating, by the warehouse management device, a merge task of merging a reference load cell having the highest loading rate among the plurality of load cells with a target load cell having the lowest loading rate among the plurality of load cells.

### CROSS-REFERENCE TO RELATED APPLICATION

This application claims priority from Korean Patent Application No. 10-2014-0116449 filed on Sep. 2, 2014 in the Korean Intellectual Property Office, and all the benefits accruing therefrom under 35 U.S.C. 119, the contents of which in its entirety are herein incorporated by reference.

### BACKGROUND

1. Technical Field

The present invention relates to a warehouse reorganization method and the computer program thereof, and more particularly to a method of efficiently managing load cells in a warehouse by relocating the items loaded in each load cell in the warehouse, and the computer program thereof.

2. Description of the Related Art

In order to efficiently store items, a warehouse has a plurality of load cells. The load cell may be formed of, e.g., a rack type or bulk type.

When the items are stocked in the warehouse, an optimal load cell for the items is selected in accordance with appropriate loading strategies. However, the loading state of the warehouse is gradually changed to become inefficient as the items are repeatedly stocked and released.

Thus, in order to optimize the loading state in the warehouse, it is necessary to reorganize the warehouse, i.e., relocate the items in the warehouse. Accordingly, it is requested to provide a systematic technique for relocating the items loaded in the warehouse.

### SUMMARY

In view of the above, the present invention provides a warehouse reorganization method of relocating items loaded in a warehouse by selecting items to be relocated and merging load cells on which the items are loaded.

The present invention also provides a computer program for generating a task of relocating items loaded in a warehouse by selecting items to be relocated and merging load cells on which the items are loaded, and allocating the task to one of operators.

However, aspects of the present invention are not restricted to those set forth herein. The above and other aspects of the present invention will become more apparent to one of ordinary skill in the art to which the present invention pertains by referencing the detailed description of the present invention given below.

According to the present invention, there is an effect of efficiently optimizing the load cells of the warehouse by automating, using a computer system, an operation for generating a task of relocating items loaded in a warehouse by selecting items to be relocated and merging load cells on which the items are loaded and allocating the task to one of operators.

Further, there is an effect of efficiently relocating the items loaded in the warehouse by managing load zones of the warehouse based on a frequency at which the item is released from the warehouse.

In some embodiments, a warehouse reorganization method comprising, selecting, by a warehouse management device, an item to be relocated, retrieving, by the warehouse management device, a plurality of load cells on which the selected item is loaded, and generating, by the warehouse management device, a merge task of merging a reference load cell having the highest loading rate among the plurality of load cells, which have not been subjected to the merge task, with a target load cell having the lowest loading rate.

In some embodiments, the warehouse reorganization method comprising, selecting, by a warehouse management device, an item to be relocated, identifying, by the warehouse management device, a plurality of load cells on which the selected item is loaded, and generating, by the warehouse management device, a merge task of merging a reference load cell having the highest loading rate among the plurality of load cells, which have not been subjected to the merge task, with a target load cell, wherein the target load cell is a load cell which has not been subjected to the merge task and is selected such that a total loading rate, which is the sum of a loading rate of the reference load cell and a loading rate of the target load cell, is closest to a loading rate limit.

In some embodiments, a computer program stored in a medium and executed on a computer device to perform the steps of, selecting an item to be relocated, retrieving a plurality of load cells on which the selected item is loaded, generating a merge task of merging a reference load cell having the highest loading rate among the plurality of load cells, which have not been subjected to the merge task, with a target load cell having the lowest loading rate, selecting an operator to perform the generated merge task, and transmitting information on the generated merge task to a terminal of the operator.

In some embodiments, the warehouse reorganization method comprising, assigning, by a warehouse management device, a level to each item stocked in a warehouse based on a frequency at which the item is released from the warehouse, generating, by the warehouse management device, a first merge task of merging a target load cell having the highest loading rate among load cells on which items having a level other than a first level are loaded in a first load zone for items having the first level with a reference load cell having the lowest loading rate in load zones other than the first load zone, and repeating, by the warehouse management device, the generating of the first merge task with respect to the load cells which have not been subjected to the first merge task until there is no more load cell on which items having a level other than the first level are loaded in the first load zone, wherein the first level is assigned to an item having the highest frequency at which the item is released from the warehouse.

In some embodiments, the warehouse reorganization method comprising, assigning, by a warehouse management device, a level to each item stocked in a warehouse based on a frequency at which the item is released from the warehouse, selecting, by the warehouse management device, a relocation target load zone which is a load zone for items having A-th level (1<=A<=N, A is a natural number, N is a natural number equal to or greater than 2), obtaining, by the warehouse management device, a list of normal load cells including load cells on which items having the A-th level are loaded in the relocation target load zone, generating, by the warehouse management device, a second merge task of merging a reference load cell having the highest loading rate among the load cells included in the list of normal load cells with a target load cell having the lowest loading rate among the load cells included in the list of normal load cells, obtaining, by the warehouse management device, a list of abnormal load cells, on which the items having the A-th level are loaded, in load zones other than the relocation target load zone, and generating, by the warehouse management device, a third merge task of merging a target load cell which is one of load cells included in the list of abnormal load cells with a reference load cell which is one of empty load cells of the relocation target load zone.

### BRIEF DESCRIPTION OF THE DRAWINGS

The above and other aspects and features of the present invention will become more apparent by describing in detail exemplary embodiments thereof with reference to the attached drawings, in which:

FIG. 1 is a flowchart showing a warehouse reorganization method according to an embodiment of the present invention;

FIG. 2 is a detailed flowchart showing some steps of the method shown in FIG. 1;

FIG. 3 is a conceptual diagram showing a loading state of load cells to explain the steps shown in FIG. 2;

FIG. 4 is a diagram explaining a method of selecting an operator to perform a merge task generated by performing the method described with reference to FIG. 1;

FIG. 5 is a flowchart showing a warehouse reorganization method according to another embodiment of the present invention;

FIGS. 6 and 7 are diagrams showing arrangement examples of load zones in the case of allocating the load zones according to the release frequency of the items stocked in the warehouse;

FIG. 8 is a detailed flowchart showing some steps of the method shown in FIG. 5;

FIG. 9 is a detailed flowchart showing some other steps of the method shown in FIG. 5;

FIG. 10 shows a hardware block diagram of an item relocation device according to another embodiment of the present invention; and

FIG. 11 shows a configuration of an item relocation system according to still another embodiment of the present invention.

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

First, the terms used herein are defined as follows.

“Item” is a unit of stocked articles to be managed in a warehouse reorganization method and a warehouse management system according to an embodiment of the present invention. Each item has a LOT which is an identifier generated by combining its type and attributes. An item may refer to a group of items having the same name, same identifier, the same type, the same attributes. Also, an item may refer to a group of items classified as the same group based on certain criteria.

“Load cell” is a space where the item can be loaded in the warehouse, and the warehouse is managed by dividing the entire space of the warehouse into a plurality of load cells. The warehouse management system may manage the identifier, the size and the attribute information of each load cell.

“Load zone” is a zone consisting of a plurality of load cells. According to the operating strategies of the warehouse management system, only the items satisfying certain criteria may be loaded in one load zone. For example, the load zones may be set on the basis of a release ratio, shipping destination and type of items.

“Task” means a unit operation generated in order to achieve the reorganization of the items loaded in the warehouse in the warehouse reorganization method and the warehouse management system according to the embodiment of the present invention. Each task is allocated to an operator of the warehouse. By motivating each operator to faithfully perform the task allocated to him/her, it is possible to achieve an effect of relocating the items loaded in the warehouse. The task allocation results are transmitted to a terminal of each operator. Each operator may check the task allocation status and the detailed information of each task by using the terminal. A priority may be assigned to each task. In this case, the terminal may guide the operator to first perform the task with high priority.

“Merge task” means a task of merging two or more load zones. For example, the merge task may be a task of one-to-one merging two load zones. In the case of merging first and second load zones such that the items loaded in the first load zone are incorporated into the second load zone, the first load zone is referred to as a target load zone and the second load zone is referred to as a reference load zone.

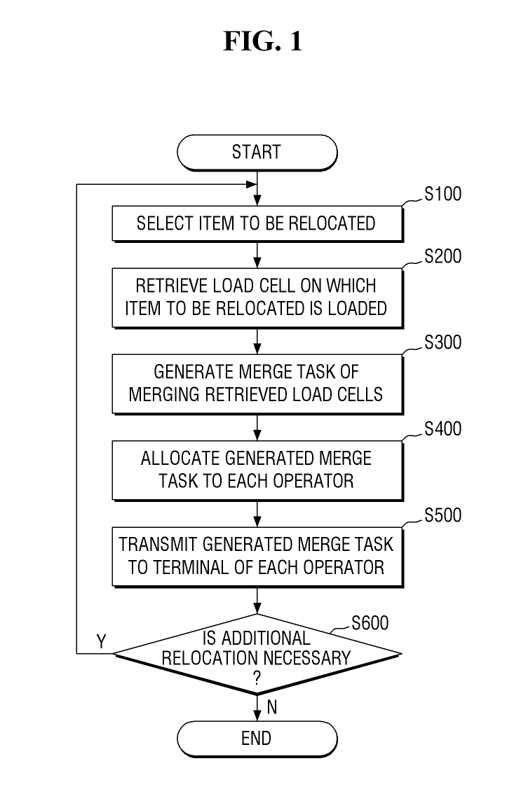

Hereinafter, a warehouse reorganization method according to one embodiment of the present invention will be described with reference to FIG. 1. The method shown in FIG. 1 may be performed by a warehouse management device including a computing unit and a network interface unit. The warehouse management device may be a server device of a warehouse management system (WMS), a server device of a warehouse operating system (WOS), an item relocation device connected to the server device of the warehouse management system (WMS), or an item relocation device connected to the server device of the warehouse operating system (WOS).

First, an item to be relocated is selected (S100). The warehouse management device may receive a user's input to specify an item to be relocated through the user interface, and select the item to be relocated from the user's input.

According to one embodiment, the item to be relocated may be selected according to the type of the item. For example, among various types of items such as a television, a smart phone, an air conditioner and a vacuum cleaner, the television may be selected as the item to be relocated.

According to one embodiment, the item to be relocated may be selected according to the attributes of the item. The attributes of the item may be criteria used to subdivide the type of the item. For example, if the type of the item is a television, the attributes of the item may be a size (inches of a display), a using country, a color and the like. For example, television products which are black in color may be selected as the item to be relocated.

According to one embodiment, the item to be relocated may be selected based on the LOT of the item. The LOT is an identifier generated by combining the attributes of the item. The items having the same LOT may be considered as the items having exactly the same attributes. For example, the LOT ‘TV42KRBL’ of the item including code ‘TV’ indicating the type of the item, and size ‘42’, using country ‘KR’, and color ‘BL’ indicating the attributes means a television product which has a size of 42 inches and is black in color and can be used in the Republic of Korea. For example, the item having the LOT ‘TV42KRBL’ may be selected as the item to be relocated.

According to one embodiment, a frequently released item having a frequency at which the item is released from the warehouse and which is equal to or greater than a predetermined value may be selected as the item to be relocated. If a reference value of the frequency at which the item is released from the warehouse is specified as more than 30 times per week and the items being released more than 30 times per week are determined as a 42-inch TV and an air conditioner, the item whose type is a television and whose size is 42 inches or the item whose type is an air conditioner may be selected as the items to be relocated.

If the frequently released items are selected as the items to be relocated, there is an effect of gathering the frequently released items in a minimum load cell. If the frequently released items are gathered in the minimum load cell, there is an effect of increasing the efficiency of a releasing operation.

According to one embodiment, the frequently stocked item having a frequency at which the item is stocked in the warehouse and which is equal to or greater than a predetermined value may be selected as the item to be relocated. If a reference value of the frequency at which the item is stocked in the warehouse is specified as more than 10 times per week and the item being released more than 10 times per week is determined as a smart phone, the item whose type is a smart phone may be selected as the item to be relocated.

According to one embodiment of the present invention, the frequently released/stocked item having a frequency at which the item is released/stocked from/in the warehouse and which is equal to or greater than a predetermined value may be selected as the item to be relocated.

Meanwhile, according to one embodiment, the item to be relocated may be selected based on the load cell instead of the item. For example, the item to be relocated may be selected based on the type of the load cell. As the type of the load cell, a rack type, a bulk type or the like may be mentioned. The type of the load cell may be subdivided by reflecting which items are to be allocated to the load cell. For example, the type of the load cell may be subdivided into a rack-normal type, a rack-damage type, a bulk-Asian export type, a bulk-European export type, and a bulk-US export type. According to one embodiment, the type of the load cell may be set such that the items loaded in the load cell are not only included in the items to be relocated, but also excluded from the items to be relocated. For example, all items loaded in the load cells except the bulk-US export type load cell among the bulk type load cells may be selected as the items to be relocated.

Next, a load cell on which the item to be relocated is loaded is retrieved (S200). The warehouse management device may manage its own database to retrieve a load cell on which each item is loaded, but may retrieve a load cell, on which the item to be relocated is loaded, from an external device. For example, the external device may be a server of the warehouse management system (WMS), or a server of the warehouse operating system (WOS). If the item to be relocated is selected on the basis of the load cell, the retrieval process is not necessary.

Next, a merge task is generated to merge the retrieved load cells, i.e., the load cells on which the items to be relocated are loaded (S300). In the present invention, the task means a unit operation associated with the warehouse management. Each task is generated independently, allocated independently to an optimal operator, and transmitted to a terminal of the operator such that the task allocated to a particular operator can be recognized by the operator.

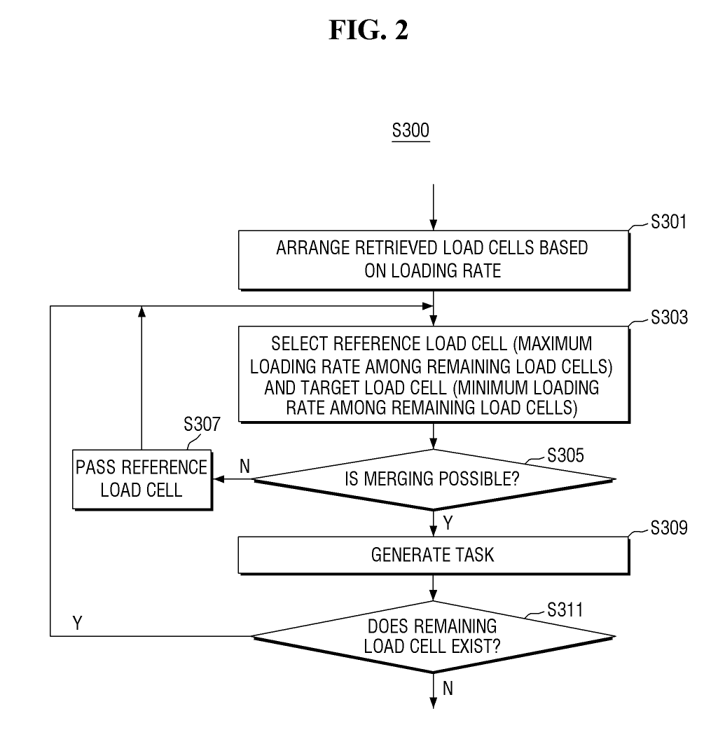

Hereinafter, a method of generating a merge task will be described in more detail with reference to FIG. 2.

First, the retrieved load cells, i.e., the load cells on which the items to be relocated are loaded are arranged on the basis of a loading rate (S301). The loading rate is a value obtained by dividing the total volume of the loaded items by the total volume of the load cell. For example, if the total volume of the load cell is 100 m², the size information (width, length, and height) of the first item loaded on the load cell is 5 m×1 m×3 m, and the size information (width, length, and height) of the second item loaded on the load cell is 1 m×3 m×2 m, since the total volume of the items loaded on the load cell is 21 m², the loading rate of the load cell is computed as 21%.

Then, the load cell having the maximum loading rate among the remaining load cells is set as a reference load cell for the merge task, and the load cell having the minimum loading rate among the remaining load cells is set as a target load cell for the merge task (S303). In this case, the maximum loading rate means the loading rate other than 100% (or a loading rate limit). This is because the load cells having the loading rate of 100% cannot be merged. Also, the minimum loading rate means the loading rate other than 0%. The remaining load cells mean the load cells other than the load cell which has already become the reference load cell or the target load cell for the merge task and the load cell which has been a candidate for the reference load cell, but has been passed because the target load cell for the merge task could not be found.

Among the remaining load cells, the load cell having the maximum loading rate becomes the reference load cell. This is because it is more efficient in operation to reduce the volume of the items to be moved by merging.

Then, it is determined whether it is possible to merge the reference load cell with the target load cell (S305). The merging means moving the items of the target load cell to the reference load cell. Only if the total loading rate, which is the sum of the loading rate of the target load cell and the loading rate of the reference load cell, is equal to or less than the loading rate limit of the reference load cell, it is determined that it is possible to merge the reference load cell with the target load cell. If merging is possible, a merge task of merging the target load cell with the reference load cell is generated (S309). After generating the merge task, if there are more remaining load cells (S311), the load cell having the second highest loading rate, which is next to the loading rate of the reference load cell, is set as a new reference load cell, and it is attempted to generate a merge task (S303).

The loading rate limit may be set to a predetermined value equal to or less than 100%. For example, the loading rate limit may be set to 90% in consideration of a margin of 10%.

If merging is impossible because the loading rate limit exceeds the loading rate of the reference load cell, the reference load cell is passed because the target load cell for the merge task does not exist (S307). Then, by setting the load cell having the second highest loading rate as a new reference load cell, and setting the load cell having the minimum loading rate among the remaining load cells as the target load cell, it is attempted to generate a merge task (S303).

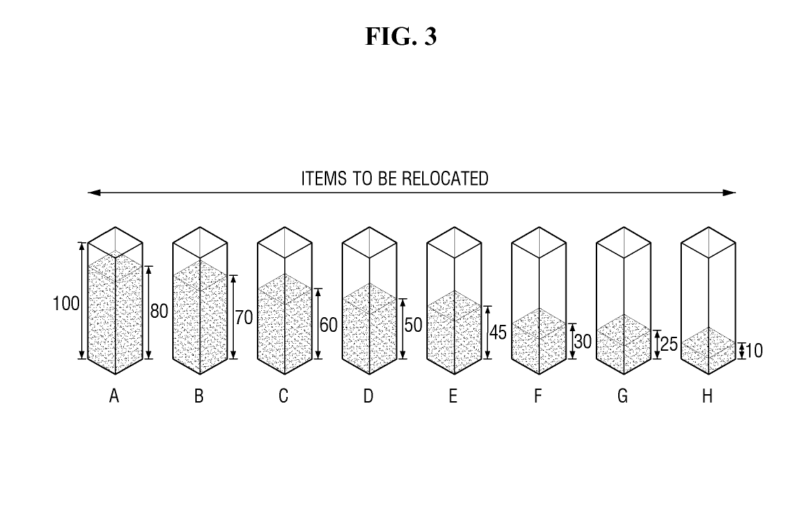

Hereinafter, a method for generating a merge task will be described again with reference to FIG. 3. FIG. 3 shows a case where there are eight load cells on which the items which have been selected as the items to be relocated are loaded. In FIG. 3, the retrieved load cells, i.e., the eight load cells on which the items to be relocated are loaded, are arranged in descending order on the basis of a loading rate. For simplicity of description, it is assumed that the loading rate limit is 100%.

First of all, load cell A is selected as the reference load cell, and load cell H is selected as the target load cell. Since the total loading rate of the load cell A and the load cell H is 90%, merging is possible.

According to one embodiment, if there is a margin in the reference load cell even after one target load cell has been merged with the reference load cell, two or more target load cells may be merged with one reference load cell. In other words, a merge task of merging the load cell having the second lowest loading rate, which is next to the loading rate of the target load cell, with the reference load cell may be further generated. Although there is load cell G having the second lowest loading rate which is next to the loading rate of the load cell H, since the total loading rate is 115% which exceeds the loading rate limit if the load cell G is further merged, only the load cell H can be merged with the load cell A.

Then, load cell B is selected as a new reference load cell, and load cell G is selected as a new target load cell. Since the total loading rate of the load cell B and the load cell G is 95%, merging is possible. Although there is load cell F having the second lowest loading rate which is next to the loading rate of the load cell G, since the total loading rate is 125% which exceeds the loading rate limit if the load cell F is further merged, only the load cell G can be merged with the load cell B.

According to another embodiment of the present invention, the target load cell may be selected so as to generate a high total loading rate while not exceeding the loading rate limit. That is, the merge task may be generated such that the reference load cell can be filled up to the loading rate limit. In other words, according to the policy of generating the merge task, the target load cell having a low loading rate may be selected, or the target load cell may be selected so as to generate a high total loading rate while not exceeding the loading rate limit. The policy of generating the merge task may be converted by a user interface.

In the case of the policy of generating the merge task by selecting the target load cell so as to generate a high total loading rate while not exceeding the loading rate limit, if the reference load cell is the load cell B, the load cell F may be selected instead of the load cell G as the target load cell for merging. This is because the total loading rate is 100% and the load cell B can be filled as much as possible if the load cell G is merged with the load cell B. Thus, in this case, the merge task of merging the load cell F with the load cell B may be generated. The following description will be made on the assumption that the policy of generating the merge task is selecting the target load cell so as to generate a high total loading rate while not exceeding the loading rate limit.

Then, the load cell C is selected as a new reference load cell. The remaining load cells are the load cell E and the load cell G which are arranged in descending order on the basis of a loading rate. In the case of the load cell E, the total loading rate of the load cell C and the load cell E exceeds the loading rate limit. In the case of the load cell G, the total loading rate of the load cell C and the load cell G does not exceed the loading rate limit (25+60=85%). Accordingly, a merge task of merging the load cell G with the load cell C is generated.

Then, the load cell D is selected as a new reference load cell. The remaining load cell is the load cell E. In the case of the load cell E, the total loading rate of the load cell E and the load cell D does not exceed the loading rate limit (45+50=95%). Accordingly, a merge task of merging the load cell E with the load cell D is generated.

In the above description with reference to FIG. 3, it has been assumed that all of the load cells A to H are not in a mixed loading state. However, when items are stocked and loaded, if there is no empty load cell, mixed loading may occur. The mixed loading state means a state in which the item to be relocated and other items are loaded at the same time in one load cell. Whether a particular load cell is in a mixed loading state may be determined based on the attribute values of each item loaded on the load cell.

If at least a part of the items to be relocated is in a mixed loading state, a merge task of merging the load cells in a non-mixed loading state may be generated in order to minimize the occurrence of mixed loading. That is, if the reference load cell is in a non-mixed loading state in which only the item to be relocated is loaded, a merge task of merging the reference load cell with the target load cell having the lowest loading rate among the load cells in a non-mixed loading state may be generated.

In addition, a merge task of merging the load cells in a mixed loading state may be generated. In other words, if the reference load cell is in a mixed loading state in which other items as well as the item to be relocated are loaded, a merge task of merging the reference load cell with the target load cell having the lowest loading rate among the load cells in a mixed loading state may be generated.

Referring again to FIG. 1, if the merge task is generated by the method described above with reference to FIGS. 2 and 3, the generated merge task is allocated to each operator (S400). The operator means an operator performing the warehouse management task.

When the merge task is allocated to each operator, the same number of merge tasks may be allocated to each operator as much as possible, or each operator may be allowed to move the same volume of items as much as possible.

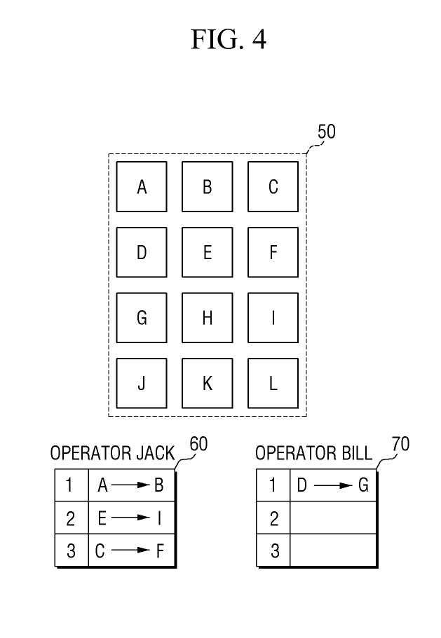

According to some embodiments, the merge task may be allocated to minimize the movement of each operator. The present embodiment will be described with reference to FIG. 4.

Let us assume that twelve load cells A to L are disposed in an inner space 50 of the warehouse. Also, let us assume that a merge task of incorporating the items of load cell A into load cell B, a merge task of incorporating the items of load cell E into load cell I, and a merge task of incorporating the items of load cell C into load cell F are pre-allocated to a task queue 60 of an operator JACK, and a merge task of incorporating the items of load cell D into load cell G is pre-allocated to a task queue 70 of an operator BILL. Further, let us assume that a newly allocated merge task is a merge task of incorporating the items of load cell J into load cell L. In this case, an operator is selected who is pre-allocated with a merge task having a reference load cell that is closest to load cell J (target load cell) from which the items are to be transferred to perform the newly allocated merge task. In the case shown in FIG. 4, the reference load cells of the merge tasks pre-allocated to the operator JACK are load cells B, I, and F, and the reference load cell of the merge task pre-allocated to the operator BILL is load cell G. Among the load cells B, I, F, and G, the load cell that is closest to the load cell J is the load cell G. Therefore, the newly allocated merge task is to be allocated to the operator BILL.

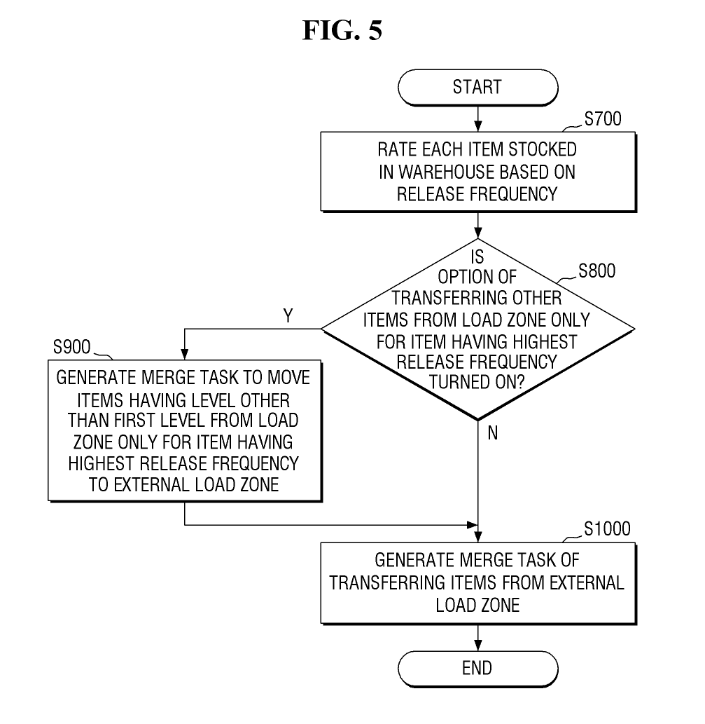

Next, a warehouse reorganization method according to another embodiment of the present invention will be described with reference to FIG. 5. The warehouse reorganization method according to the present embodiment is different from the warehouse reorganization method described with reference to FIGS. 1 to 3 in that the load zones of the warehouse are managed based on a release frequency at which the item is released from the warehouse.

The method shown in FIG. 5 may also be performed by a warehouse management device including a computing unit and a network interface unit. The warehouse management device may be a server device of a warehouse management system (WMS), a server device of a warehouse operating system (WOS), an item relocation device connected to the server device of the warehouse management system (WMS), or an item relocation device connected to the server device of the warehouse operating system (WOS).

First, each item stocked in the warehouse is rated based on the release frequency (S700). The rating may be divided into a predetermined number of levels. Further, a release frequency level may one-to-one correspond to each load zone. For example, a first load zone may include load cells on which the items of a first level are loaded. That is, if the number of load zones managed in the warehouse is five, the rating may be given by being divided into five release frequency levels.

The rating may be given based on the release record for a specified time period. For example, if items A, B, C, D, and E have values of 100, 90, 60, 45, and 30, respectively, in terms of the number of products released for three months, their release quantity ratios are 33%, 30%, 20%, 15%, and 10%, respectively. If the rating is divided into three levels (first level: equal to or greater than 30%, second level: equal to or greater than 12% and less than 30%, and third level: less than 12%), the first level, the first level, the second level, the second level, and the third level are assigned to the items A, B, C, D, and E, respectively.

In order to facilitate understanding, it is assumed that the rating is divided into N levels, which are represented as the first level, the second level, . . . , the N-th level in descending order of the release frequency. The load zone for the items of the first level is referred to as a first load zone, the load zone for the items of the second level is referred to as a second load zone, . . . , and the load zone for the items of the N-th level is referred to as an N-th load zone.

The rating may be given by distinguishing the items, and criteria on which the items are distinguished based may be set previously. For example, if the items are distinguished based on the type of items, the items A, B, C, D, and E may be a smart phone, a television, an air conditioner, a washing machine, and a vacuum cleaner sequentially, respectively. Further, in a case where only a specific type of items are stocked in the warehouse, the items may be distinguished based on the attributes of the item. For example, the items A, B, C, D, and E may be a TV having a size of 30 inches or less, a TV having a size from 30 to 39 inches, a TV having a size from 40 to 49 inches, a TV having a size from 50 to 59 inches, and a TV having a size of 60 inches or more sequentially, respectively. In this case, in order to assign the level to the item based on the release frequency, the size information (inches) is checked from the attribute information of the item. For example, in the case of an item whose type is a television and whose size is 46 inches, the second level is assigned to the item.

According to another embodiment, a level may be pre-assigned to each item. In this case, the level may be used as it is.

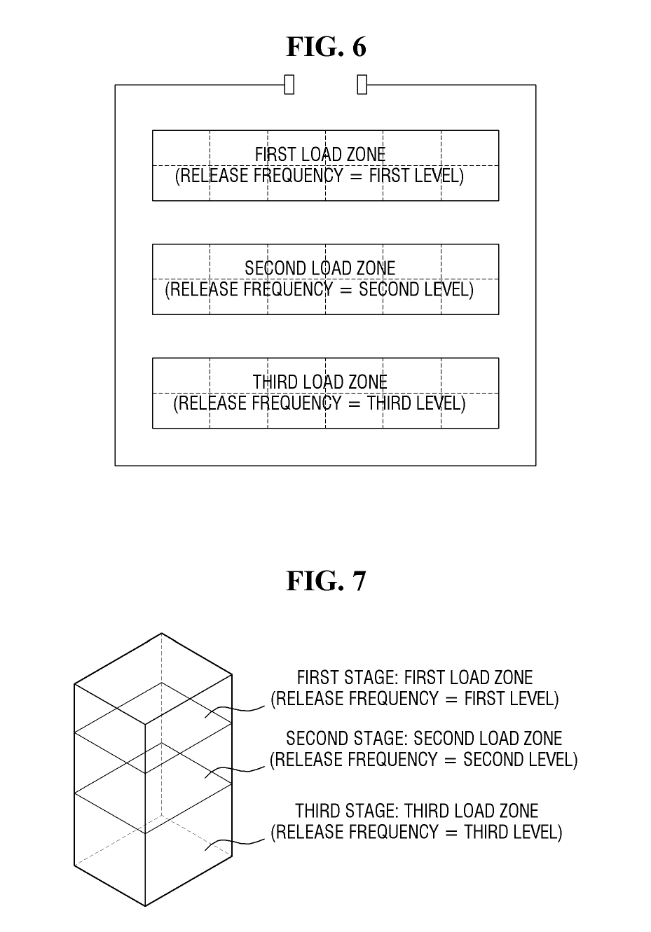

FIGS. 6 and 7 illustrate arrangement examples of load zones in the warehouse. According to one embodiment, as shown in FIG. 6, the load zones may be arranged by dividing a horizontal space. According to another embodiment, as shown in FIG. 7, the load zones may be arranged by dividing a vertical space. If the level is assigned to each item based on the release frequency, it is preferable that the first load zone is disposed at a place from which the item can be easily released. In consideration of this point, as shown in FIG. 6, the first load zone may be disposed at a position closest to the entrance of the warehouse. Further, if load zones having a multi-stage rack structure are managed, the first load zone may be disposed at the first stage.

Then, it is checked whether an option of transferring other items from the load zone only for the item having the highest release frequency to an external load zone is selected (S800). The item having the highest release frequency means an item to which the highest level (first level) has been assigned. If the option is selected, items not having the first level need to be transferred from the load zone (first load zone) only for the items having the first level to another load zone.

If the option is selected, first, the items having the level other than the first level are transferred from the first load zone to an external load zone, and an empty load cell is created. Then, the items having the first level stocked in the load zones other than the first load zone may be transferred to the first load zone. If the option is not selected, without performing an operation of transferring the items having the level other than the first level from the first load zone to an external load zone, the items having the first level stocked in load zones other than the first load zone are transferred to the first load zone. Therefore, if the option is not selected, the items having the level other than the first level may remain in the first load zone even after the relocation of the items loaded in the warehouse.

If the option is selected, a merge task is generated in order to first transfer the items having the level other than the first level from the first load zone to an external load zone (S900). In order to facilitate understanding, the merge task generated to first transfer the items having the level other than the first level from the first load zone to an external load zone is referred to as a first merge task. Hereinafter, an operation for generating the first merge task will be described in detail.

First, among the load cells included in the first load zone, the load cells on which the items having the second to N-th levels are loaded are retrieved (S901). Since the retrieved load cells should not be loaded on the first load zone, the retrieved load cells are to be transferred to the second to N-th load zones by performing the first merge task.

Then, the retrieved load cells are arranged on the basis of a loading rate (S903). Further, the load cells included in the second to N-th load zones are arranged on the basis of a loading rate (S905).

Then, the reference load cell and the target load cell for the first merge task are selected (S907). The reference load cell is a load cell having the minimum loading rate among the load cells which are included in the second to N-th load zones and have not yet become the reference load cell for the first merge task. In this case, the minimum loading rate means the loading rate other than 0%. The target load cell is a load cell having the maximum loading rate among the load cells which are included in the second to N-th load zones and have not yet become the reference load cell for the first merge task. In this case, the maximum loading rate includes the loading rate of 100% (or the same loading rate as the loading rate limit).

After selecting the reference load cell and the target load cell for the first merge task, by determining whether the total loading rate, which is the sum of the loading rate of the reference load cell and the loading rate of the target load cell, exceeds the loading rate limit, it is determined whether it is possible to merge the target load cell with the reference load cell (S909). According to some embodiments, if it is determined that merging is impossible because the total loading rate exceeds the loading rate limit, the target load cell of the first load zone may be passed as failing to be transferred to the outside from the first load zone (S911). According to another embodiment, a merge task of merging the target load cell with one of empty load cells of the second to N-th load zones may be generated.

If it is determined that merging is possible, the first merge task is generated (S913), and if a load cell on which the items having the second to N-th levels are loaded is still present in the first load zone, an operation of generating the first merge task for transferring the load cell to an external load zone is repeated (S907, S909, S911, S913).

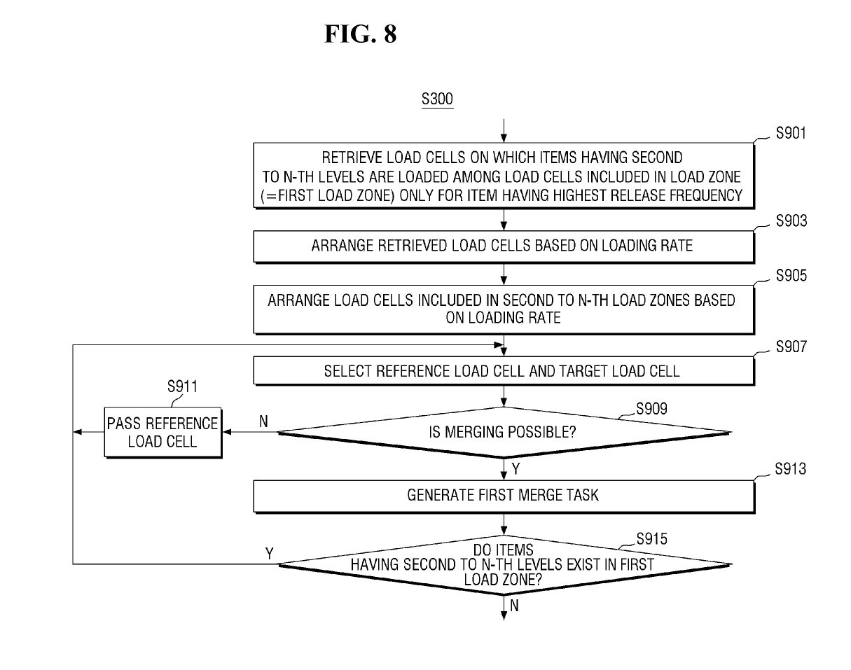

As a result of performing the method shown in FIG. 8, only the items of the first level remain in the first load zone.

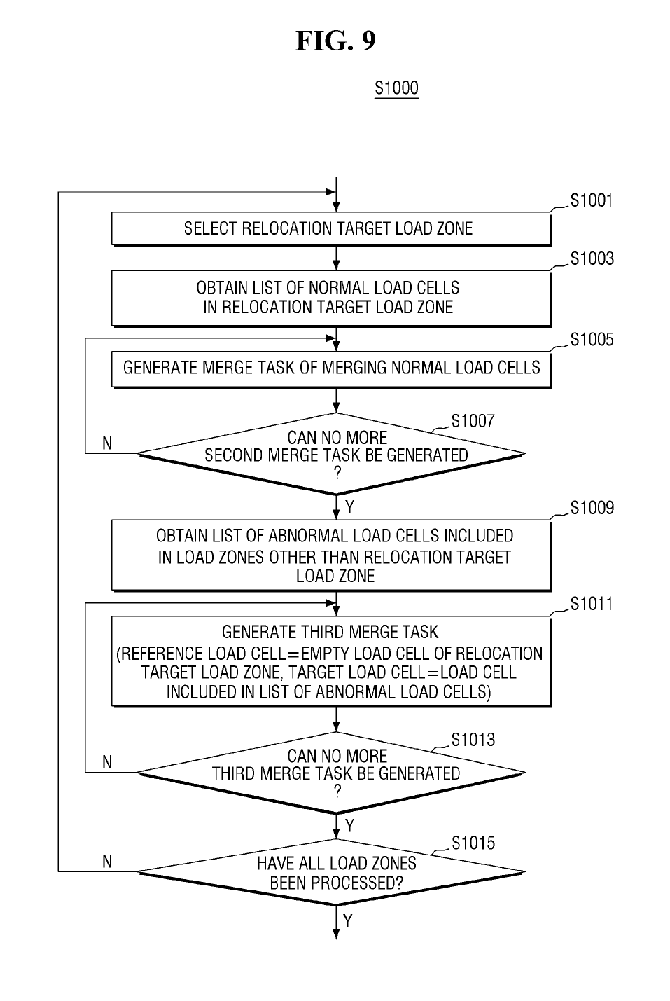

Next, an operation of generating a merge task of transferring items from an external load zone (S1000) will be described in detail with reference to FIG. 9. The operation shown in FIG. 9 is an operation which is performed for each relocation target load zone in the form of a merge task to move the items loaded in other load zones to the relocation target load zone on which the items are supposed to be loaded.

First, a relocation target load zone is selected (S1001). As mentioned earlier in the description with reference to FIG. 5, if an option of transferring other items from the load zone only for the item having the highest release frequency to an external load zone is selected, the first load zone is to be selected as the relocation target load zone. If the option is not selected, the relocation target load zone may be selected according to a manager's input, or the relocation target load zone may be automatically selected according to the previously specified policy. Alternatively, the first to N-th load zones may be sequentially selected as the relocation target load zone.

Then, a list of normal load cells in the selected relocation target load zone is obtained (S1003). The list of normal load cells includes load cells, each having the items with the matched level, in the relocation target load zone.

Then, a merge task of merging normal load cells is generated (S1005). The merge task generated in this case is referred to as a second merge task. The second merge task is generated in order to secure empty load cells as many as possible by collecting the items loaded properly in the relocation target load zone. Each of the secured empty load cells may be used as a reference load cell for a merge task of transferring the items with the matched level, which are loaded in load zones other than the relocation target load zone, to the relocation target load zone.

A method of generating the second merge task is similar to that described with reference to FIG. 1. That is, a load cell having the maximum loading rate among the normal load cells, which have not been subjected to the second merge task, becomes a reference load cell, and a load cell having the minimum loading rate among the normal load cells, which have not been subjected to the second merge task, becomes a target load cell. In this case, if the total loading rate, which is the sum of the loading rate of the reference load cell and the loading rate of the target load cell, exceeds the loading rate limit, the reference load cell may be passed because merging is impossible. In this case, the maximum loading rate means the loading rate other than 100% (or the same loading rate as the loading rate limit). This is because the load cells having the loading rate of 100% cannot be merged. Also, the minimum loading rate means the loading rate other than 0%.

The generation of the second merge task is repeated until no more second merge task can be generated (S1007). It is determined that no second merge task can be generated when the number of normal load cells which have not been subjected to the second merge task is equal to or less than 1 without being passed because merging is impossible.

When all of the generated second merge tasks are performed, one or more empty load cells are newly provided by merging the normal load cells included in the relocation target load zone.

After the generation of the second merge task is completed, a list of abnormal load cells, which are included in load zones other than the relocation target load zone and on which the items with the level matched with the relocation target load zone are loaded, is obtained or retrieved (S1009).

Then, a third merge task is generated (S1011). The third merge task is a merge task of moving the items loaded in other load zones to the relocation target load zone on which the items are supposed to be loaded. Thus, the target load cell of the third merge task is one of load cells included in the list of abnormal load cells. Further, the reference load cell of the third merge task is one of empty load cells of the relocation target load zone.

According to one embodiment, the load cell which becomes a new empty load cell after the second merge task has been completed may also be the reference load cell.

According to one embodiment, the third merge task may be generated by one-to-one merging at least some of load cells included in the list of abnormal load cells with at least some of empty load cells of the relocation target load zone. For example, although there are two empty load cells C1 and C2 in the relocation target load zone and there are four load cells C3, C4, C5, and C6 in the list of abnormal load cells, only two abnormal load cells may be transferred to the relocation target load zone. This is because only two empty load cells are present in the relocation target load zone.

According to another embodiment, the third merge task may be generated so as not to change the reference load cell until it is impossible to merge more load cells. This is to move items as many as possible to the load zone on which the items are supposed to be loaded. For example, a method of generating the third merge task will be described by assuming a case where there are two empty load cells C1 and C2 in the relocation target load zone and there are four load cells C3 (loading rate of 20%), C4 (loading rate of 10%), C5 (loading rate of 40%), and C6 (loading rate of 70%) in the list of abnormal load cells.

First, the abnormal load cells included in the list are arranged on the basis of a loading rate. A load cell having the minimum loading rate among the load cells, which have not been subjected to the third merge task, is selected as a target load cell, and one of empty load cells of the relocation target load zone is selected as a reference load cell. As a result, a third merge task of merging the load cell C4 (loading rate of 10%) with the load cell C1 is generated. A result of performing the third merge task is also computed, and the loading rate of the load cell C1 is 10%.

Then, the load cell C3 (loading rate of 20%) is selected as a target load cell. Even if the load cell C3 is merged with the load cell C1, the total loading rate does not exceed the loading rate limit. Accordingly, the load cell C1 is maintained as the reference load cell. As a result of performing the third merge task to merge the load cell C3 with the load cell C1, the loading rate of the load cell C1 is increased to 30% (10%+20%).

Then, the load cell C5 (loading rate of 40%) is selected as a target load cell. Even if the load cell C5 is merged with the load cell C1, the total loading rate does not exceed the loading rate limit. Accordingly, the load cell C1 is maintained as the reference load cell. As a result of performing the third merge task to merge the load cell C5 with the load cell C1, the loading rate of the load cell C1 is increased to 70% (30%+40%).

Then, the load cell C6 (loading rate of 70%) is selected as a target load cell. If the load cell C6 is merged with the load cell C1, the total loading rate exceeds the loading rate limit. Accordingly, the reference load cell is changed to the load cell C2. As a result of performing the third merge task to merge the load cell C6 with the load cell C2, the loading rate of the load cell C2 is increased to 70%.

The generation of the third merge task is repeated until no more third merge task can be generated because empty load cells of the first load zone are eliminated, or the third merge task is generated for all load cells included in the list of abnormal load cells (S1013).

If the generation of the third merge task is completed, the items which are loaded in load zones other than the relocation target load zone and have the level matched with the relocation target load zone are moved to the relocation target load zone as many as possible.

After the generation of the third merge task is completed, it is determined whether it is necessary to select the next relocation target load zone (S1015). For example, in the case of requiring the relocation only for the first load zone, the reorganization method is ended if the generation of the third merge task is completed. In the case of requiring the relocation for all load zones in the warehouse, after the relocation of the first load zone is finished, another load zone (e.g., second load zone) is selected as the relocation target load zone (S1001).

The warehouse reorganization method according to embodiments of the present invention, which has been described with reference to FIGS. 1 to 9, may be implemented as computer-readable codes on a computer-readable medium. The computer-readable medium may be, for example, a portable recording medium such as CD, DVD, Blu-ray disk, USB storage device, and portable hard disk, or a fixed recording medium such as ROM, RAM, and computer's hard disk. The computer program recorded in a recording medium readable by a computer may be transferred to another computing device via a network such as the Internet and installed on the another computing device, so that it can be used in the another computing device.

Further, according to still another embodiment of the present invention, a computer program for performing each step of the warehouse reorganization method according to embodiments of the present invention, which has been described with reference to FIGS. 1 to 9, may be provided. The computer program may be executed in conjunction with a device having a computing unit such as a computer and a smart phone, and may be recorded on a computer-readable medium.

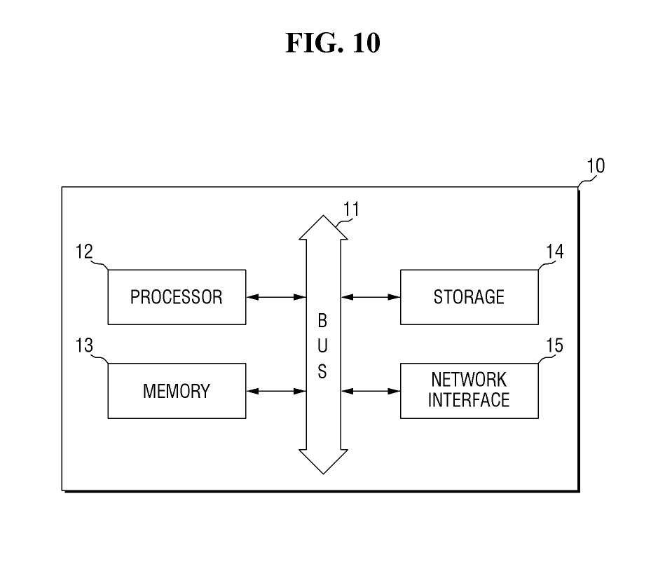

A configuration and operation of an item relocation device according to still another embodiment of the present invention will be described with reference to FIG. 10. An item relocation device 10 according to the present embodiment may include a system bus 11, a processor 12, a memory (e.g., Random Access Memory) 13, a storage 14, and a network interface 15 for communication with an external device. The computer program codes for implementing the warehouse reorganization method according to embodiments of the present invention, which has been described with reference to FIGS. 1 to 9, may be stored in the storage 14, loaded in the memory 13 and executed by the processor 12.

According to one embodiment, information about the items loaded in the warehouse may be stored in the storage 14. According to another embodiment, information about the items loaded in the warehouse may be received from an external device via the network interface 15. The external device may be a server of the warehouse management system (WMS) or a server of the warehouse operating system (WOS).

As a result of executing the computer program codes, the item relocation device 10 according to the present embodiment may generate a merge task for performing an relocation operation, allocate the generated merge task to operators, and transmit information about the allocated task to a terminal of each operator.

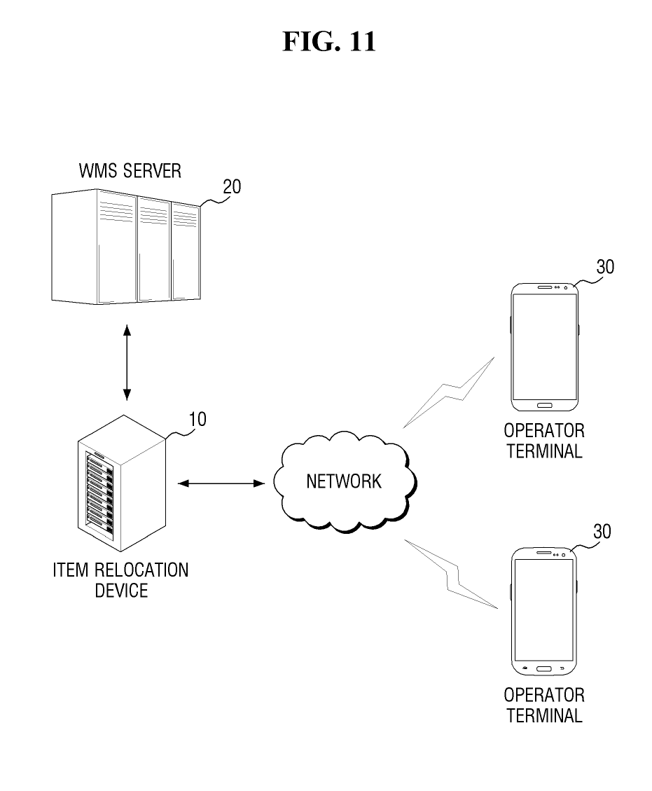

FIG. 11 shows a configuration of an item relocation system according to still another embodiment of the present invention. The item relocation system according to the present embodiment may include an item relocation device and operator terminals 30, each being provided to each operator.

According to one embodiment, the item relocation device 10 may be connected to a WMS server 20 and provided with information about the items loaded in the warehouse. The item relocation device 10 may generate merge tasks for performing an item relocation operation in the warehouse based on the provided information, allocate the generated merge tasks to operators, and transmit information about the allocated tasks to the operator terminals 30 via the network.

Although FIG. 11 illustrates that the WMS server 20 and the item relocation device 10 are separated physically, the WMS server 20 and the item relocation device 10 may be implemented as different software modules in one physical computer device, or the item relocation device 10 may be implemented as a part of the software modules of the WMS server 20.

The operator terminals 30 may be various types of mobile terminals such as a smart phone, a wearable computer, and a personal digital assistant (PDA). Each of the operator terminals 30 includes a processor (not shown) to execute a software routine that implements a task queue for managing the allocated merge tasks. The processor of the operator terminal 30 may further execute a software routine for adjusting a sequence of performing the merge tasks such that the merge tasks in the task queue are performed to have a minimum moving distance. The processor of the operator terminal 30 may further execute a software routine for displaying a graphic user interface (GUI) which receives an execution status of each merge task from the operator, and guides the next operation.

The operator terminals 30 may transmit the information about the execution status of the merge tasks received from the operators to the item relocation device 10 via the network in real time. The item relocation device 10 may generate dashboard information indicating the overall progress status of the item relocation operation by collecting the information about the execution status of the merge tasks received in real time from the operator terminals 30, and transmit the dashboard information to a dashboard monitor (not shown).

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A warehouse reorganization method comprising:
determining, by a warehouse management device, an item to be relocated;
retrieving, by the warehouse management device, a plurality of load cells on which the determined item is loaded and to which a merge task has not been applied; and
generating, by the warehouse management device, a merge task of merging a reference load cell having the highest loading rate among the plurality of load cells with a target load cell having the lowest loading rate among the plurality of load cells.

2. The warehouse reorganization method of claim 1, further comprising:
repeating the generating the merge task until no more merge task can be generated with respect to the plurality of load cells.

3. The warehouse reorganization method of claim 1, wherein the generating the merge task comprises generating a merge task of merging the reference load cell with the target load cell in response to a total loading rate, which is a sum of a loading rate of the reference load cell and a loading rate of the target load cell, being equal to or less than a loading rate limit of the reference load cell.

4. The warehouse reorganization method of claim 1, wherein the generating the merge task comprises generating a merge task of merging an additional target load cell having the second lowest loading rate among the plurality of load cells with the reference load cell.

5. The warehouse reorganization method of claim 1, wherein the generating the merge task comprises generating, in response to the reference load cell being in a mixed loading state in which other items as well as the item to be relocated are loaded, a merge task of merging a target load cell, which has the lowest loading rate among the plurality of load cells and is in the mixed loading state, with the reference load cell.

6. The warehouse reorganization method of claim 1, wherein the generating the merge task comprises generating, in response to the reference load cell being in a non-mixed loading state in which only the item to be relocated is loaded, a merge task of merging a target load cell, which has the lowest loading rate among the plurality of load cells and is in the non-mixed loading state, with the reference load cell.

7. The warehouse reorganization method of claim 1, wherein the determining the item to be relocated comprises determining a frequently released item having a frequency, at which the item is released from a warehouse and which is equal to or greater than a predetermined value, as the item to be relocated.

8. The warehouse reorganization method of claim 1, wherein the determining the item to be relocated comprises determining a frequently stocked item having a frequency, at which the item is stocked in a warehouse and which is equal to or greater than a predetermined value, as the item to be relocated.

9. The warehouse reorganization method of claim 1, further comprising:
determining an operator to which the merge task is to be allocated based on a distance between a reference load cell of a merge task pre-allocated to each operator and the target load cell of the merge task to be allocated; and
transmitting information on the allocated merge task to a terminal of the determined operator.

10. A warehouse reorganization method comprising:
determining, by a warehouse management device, an item to be relocated;
identifying, by the warehouse management device, a plurality of load cells on which the determined item is loaded and to which a merge task has been applied; and
generating, by the warehouse management device, a merge task of merging a reference load cell having the highest loading rate among the plurality of load cells with a target load cell,
wherein the target load cell is a load cell to which the merge task has not been applied and is determined such that a total loading rate, which is a sum of a loading rate of the reference load cell and a loading rate of the target load cell, is closest to a loading rate limit in comparison with sums of the loading rate of the reference load cell and loading rates of remaining load cells.

11. A non-transitory computer readable storage medium storing a program that is executable by a computer to perform a method comprising:
determining an item to be relocated;
retrieving a plurality of load cells on which the determined item is loaded and to which a merge task has not been applied;
generating a merge task of merging a reference load cell having the highest loading rate among the plurality of load cells with a target load cell having the lowest loading rate among the plurality of load cells;
determining an operator to perform the generated merge task; and
transmitting information on the generated merge task to a terminal of the operator.

12. A warehouse reorganization method comprising:
assigning, by a warehouse management device, a level to each item stocked in a warehouse based on a frequency at which the item is released from the warehouse;
generating, by the warehouse management device, a first merge task of merging a target load cell having the highest loading rate among load cells on which items having a level other than a first level are loaded in a first load zone with a reference load cell having the lowest loading rate in load zones other than the first load zone; and
repeating, by the warehouse management device, the generating the first merge task with respect to the load cells to which the first merge task has not been applied until the first load zone has no more load cell on which items having a level other than the first level are loaded,
wherein the first level is assigned to an item having the highest frequency at which the item is released from the warehouse.

13. A warehouse reorganization method comprising:
assigning, by a warehouse management device, a level to each item stocked in a warehouse based on a frequency at which the item is released from the warehouse;
determining, by the warehouse management device, a relocation target load zone which is a load zone for items having A-th level, A being a natural number which is equal to or greater than 1 and is equal to or less than N, N being a natural number which is equal to or greater than 2;
obtaining, by the warehouse management device, a list of normal load cells including load cells on which items having the A-th level are loaded in the relocation target load zone;
generating, by the warehouse management device, a second merge task of merging a reference load cell having the highest loading rate among the load cells included on the list of normal load cells with a target load cell having the lowest loading rate among the load cells included on the list of normal load cells;
obtaining, by the warehouse management device, a list of abnormal load cells, on which the items having the A-th level are loaded, in load zones other than the relocation target load zone; and
generating, by the warehouse management device, a third merge task of merging a target load cell which is one of load cells included on the list of abnormal load cells with a reference load cell which is one of empty load cells in the relocation target load zone.

14. The warehouse reorganization method of claim 13, wherein the target load cell merged through the third merge task has the lowest loading rate among load cells included on the list of abnormal load cells.

15. The warehouse reorganization method of claim 13, wherein the generating the second merge task comprises generating the second merge task until no more second merge task can be generated with respect to the load cells, to which the second merge task has not been applied, in the relocation target load zone.

16. The warehouse reorganization method of claim 13, wherein the empty load cells in the relocation target load zone include load cells which become empty after the second merge task is performed.

17. The warehouse reorganization method of claim 16, wherein the second merge task has a priority higher than a priority of the third merge task.

18. The warehouse reorganization method of claim 13, wherein the generating the third merge task comprises repeating the generating the third merge task until empty load cells in the first load zone are eliminated, or the third merge task is generated for all load cells included on the list of abnormal load cells, and
wherein the method further comprises, in response to a total loading rate, which correspond to a sum of a loading rate of the reference load cell and a loading rate of the target load cell of the third merge task, exceeding a loading rate limit, changing the reference load cell another one of the empty load cells in the relocation target load zone.

19. The warehouse reorganization method of claim 18, further comprising when no more third merge task can be generated, redetermining another relocation target load zone, and performing the obtaining the list of normal load cells, the generating the second merge task, the obtaining the list of abnormal load cells and the generating the third merge task on the redetermined relocation target load zone.
